(19) United States
(12) Patent Application Publication
(10) Pub. No.: US 2003/0085483 A1
(43) Pub. Date: May 8, 2003

(54) Apparatus and method for making molded foam articles

(75) Inventor: Charles Kroeger, Loveland, OH (US)

Correspondence Address: SHELDON & MAK, Suite 900, 225 South Lake Avenue, Pasadena, CA, 91101, US

(73) Assignee: Caco Pacific Corporation

(21) Appl. No.: 10/011,950

(22) Filed: Nov. 5, 2001

(51) Int. Cl. B29C 44/38

(52) U.S. Cl. 264/51; 425/4 R; 425/449; 425/451.9

(57) ABSTRACT

A mold apparatus useful for making molded foam articles has a pair of independently operated mold modules, both fed by a single hot melt injection unit. In a preferred, but not necessary, embodiment, each of the opposed mold portions of each mold module is retained in its respective closed position by a simple mechanical latch. In such a preferred embodiment, it is further preferred that, in the closed position, the two mold portions of each mold module are separated by a narrow air gap to allow air to escape from each mold module during operation.

### FIELD OF THE INVENTION

This invention relates generally to methods and apparatuses for making molded articles and, more specifically, to methods and apparatuses for making molded foam articles.

### BACKGROUND OF THE INVENTION

The manufacture of foamed articles by a molding process is very common. The manufacture of foamed articles by a molding process typically uses a large mold having multiple mold cavities. Each mold cavity defines the shape of the foamed articles desired. The operation of the mold is a continuously repeated batch operation. During each batch cycle, heated feedstock is injected into each of the mold cavities, and retained within those mold cavities for the period of time necessary to allow the foamed articles to form and harden. Thereafter, the foamed articles are removed from the mold cavities and a new batch cycle is commenced.

Unfortunately, several problems regarding this manufacturing process continue to exist. One problem arises from the tendency of the mold apparatus to “overcook” the feedstock before it is injected into the mold cavities. The feedstock is a blend of thermoplastic resins and a blowing agent. During operation, the blend is maintained in a hopper proximate to the mold. At the beginning of each cycle, an amount of the blend necessary to charge each of the mold cavities is removed from the reservoir and heated in an injection unit. After the previous batch of foamed articles is removed from the mold, the heated blend within the injection unit is injected into the mold cavities to form a new batch of foamed articles. The problem arises because the period of time necessary for forming foamed articles within the mold cavities is a relatively long period of time compared to the time necessary to heat the next batch of feedstock blend. During this time, the next batch of feedstock blend tends to “overcook” within the injection unit. For example, in a typical molding cycle, the total cycle time is about 30 seconds. Of this time, only about 5 seconds is necessary for the injection of heated blend into the mold and only another 10 seconds is necessary to draw in new blend from the blend reservoir. During the remaining 15 seconds of the 30-second cycle, the blend merely sits within the injection unit in a heated state. Because the blend contains a blowing agent, the excessive time spent within the injection unit is detrimental to the blend.

A second problem regarding the molding of foamed articles arises from the fact that the prior art molding processes are carried out in a traditional injection molding device wherein the opposed halves of the mold device are held in the closed position by a hydraulic clamp. The use of such a hydraulic clamp requires some very large and expensive machinery. In a typical large capacity mold apparatus of the prior art, such a clamp must typically be as large as 400 tons. Such a clamp is obviously very expensive to build, operate and maintain.

Accordingly, there is a need for an apparatus useful in the molding of foamed articles which avoids the aforementioned problems in the prior art.

### SUMMARY

The invention satisfies this need. In one embodiment of the invention, the invention is a mold apparatus useful for making molded foam articles. The mold apparatus comprises (a) a first mold module having a plurality of mold cavities, the first mold module comprising a first portion and a second portion, the first portion and the second portion being moveable with respect to one another between an open position and a closed position, (b) a second mold module having a plurality of mold cavities, the second mold module comprising a first portion and a second portion, the first portion of the second mold module and the second portion of the second mold module being moveable with respect to one another between an open position and a closed position, and (c) a hot melt injection unit for heating and delivering one or more components of a molded foam article feedstock, the hot melt injection unit being capable of alternatively directing feedstock to the first mold module or to the second mold module.

In another embodiment, the invention is also a mold apparatus, but comprising the following features: (a) a first mold portion and a second mold portion, the first mold portion and the second mold portion being moveable with respect to one another between an open position and a closed position, and (b) a hot melt injection unit for heating and delivering one or more components of a molded foam article feedstock, the hot melt injection unit being capable of alternatively directing feedstock to the first mold module or to the second mold module. When the first mold portion and the second mold portion are disposed within the closed position, an air gap is provided between the first mold portion and the second mold portion, the air gap being between 0.005 inches and 0.020 inches.

In other embodiments of the invention, the invention is a method of making molded foam articles from either of the two apparatuses described above.

### DRAWINGS

These features, aspects and advantages of the present invention will become better understood with regard to the following description, appended claims and accompanying figures where:

FIG. 1 is a diagrammatic top view of a mold apparatus having features of the invention;

FIG. 2 is a diagrammatic detail view of the distributor head used in the apparatus illustrated in FIG. 1;

FIG. 3 is a diagrammatic detail view of an alternative distributor head useable in the invention; and

FIG. 4 is a diagrammatic detail view of a second alternative distributor head useable in the invention.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

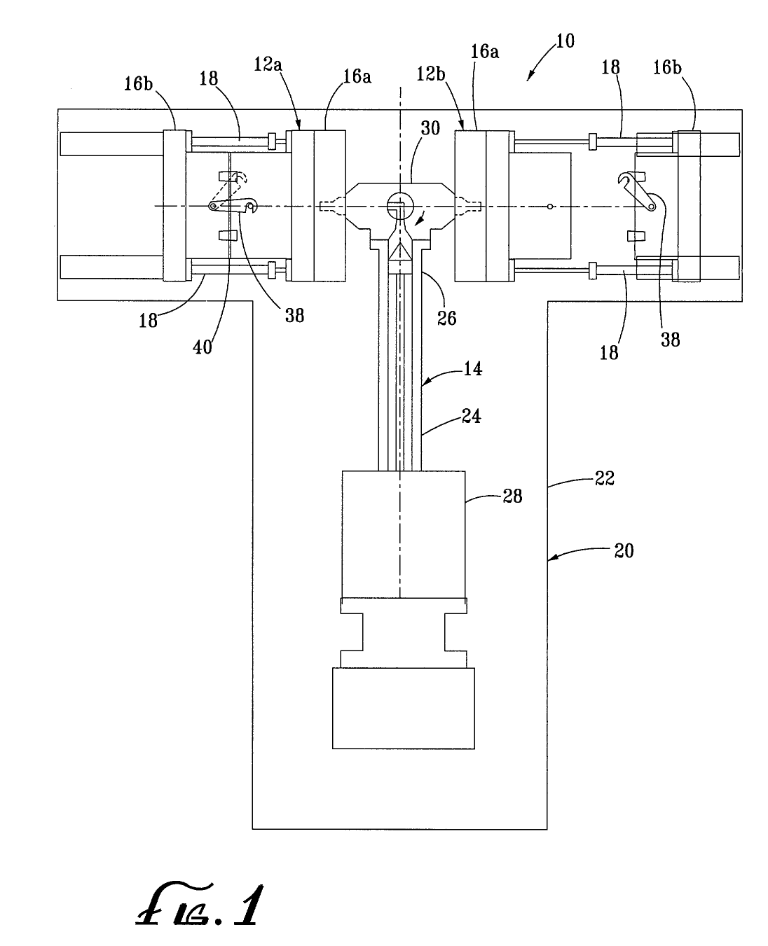

As illustrated in FIG. 1, the invention is a mold apparatus 10 having a first mold module 12a, a second mold module 12b and a common hot melt injection unit 14. Both the first mold module 12a and the second mold module 12b have a plurality of mold cavities for producing molded articles.

Each mold module 12 comprises a first mold portion 16a and a second mold portion 16b. The first mold portion 16a and the second mold portion 16b are movable with respect to one another so as to be capable of alternatively moving between a closed position, wherein the mold cavities are substantially closed, and an open position, whereby articles molded within the mold cavities can be removed from the mold cavities. In the embodiment illustrated in the drawings, the first portion 16a of each mold module 12 is stationary and the second portion 16b of each mold module 12 is movable between the open position and the closed position.

In the embodiment illustrated in FIG. 1, the second portion 16b of each mold module is made movable by a pair of light duty linear actuators 18. The linear actuators 18 are typically hydraulic actuators although other light duty linear actuators can be used.

The first mold module 12a and the second mold module 12b are mounted on a machine base 20. In the embodiment illustrated in the drawings, the machine base 20 is T-shaped. The hot melt injection unit 14 is mounted on the central section 22 of the machine base 20. The hot melt injection unit 14 is a typical hot melt injection unit known to the art, except with respect to its connection to the mold modules 12. The injection unit 14 has an upstream end 24 and a downstream end 26. The upstream end 24 is disposed in fluid tight communication with a hopper 28. The downstream end 26 is disposed in fluid tight communication with both the first mold module 12a and the second mold module 12b as described below. At the downstream end 26 of the injection unit 14 is a distributor head 30. Unlike distributor heads 30 of the prior art, the distributor head 30 in the injection unit 14 of the invention 10 is configured to be capable of alternatively directing feedstock to the first mold module 12a or to the second mold module 12b.

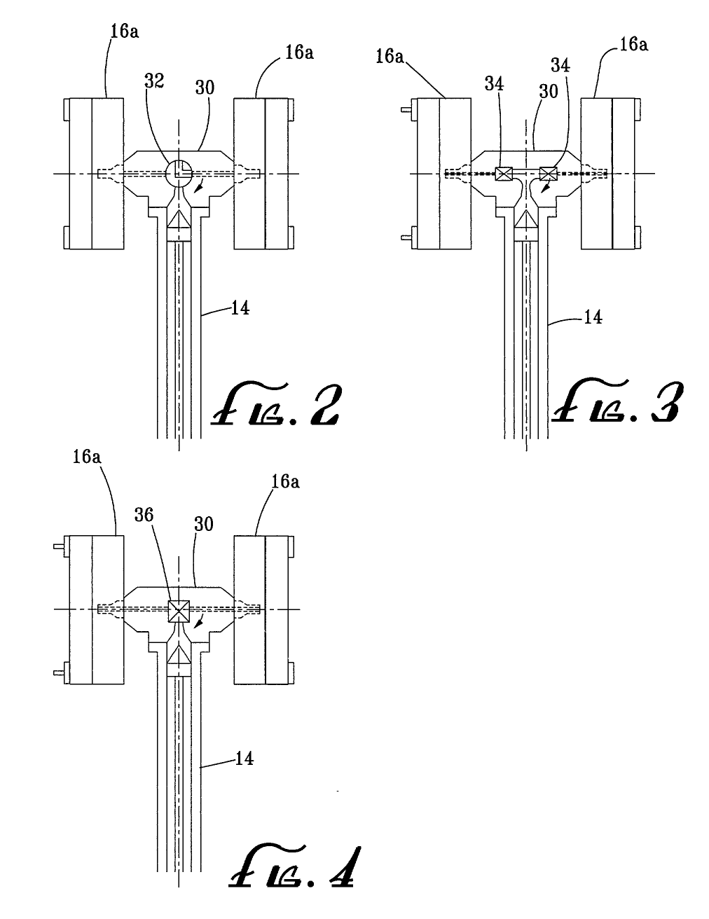

In the embodiment illustrated in FIGS. 1 and 2, the distributor head 30 comprises a rotary valve 32 capable of directing feedstock to the first mold module 12a or to the second mold module 12b. In FIG. 3, an alternative embodiment is illustrated in which the distributor head 30 comprises a manifold having two independently controllable valves 34. In FIG. 4, another alternative embodiment is illustrated in which the distributor head 30 comprises a three-way valve 36.

In the embodiment illustrated in FIG. 1, the two portions 16 of each mold module 12 are retained in their closed position by a mechanical latch 38. In FIG. 1, such a mechanical latch 38 is shown to be a simple hook-type latch. A wide variety of other mechanical latches can also be used. In all cases, however, the mechanical latch 38 is preferably a simple, lightweight and inexpensive device. The use of a mechanical latch 38 to retain the mold portions 16 in the closed position is made possible by the fact that the interior pressure within each mold cavity, when the mold module 12 is in use, is relatively small compared to the interior pressure in the mold cavities in traditional injection molding operations. (In traditional injection molding operations, a high interior pressure is required to assure that each mold cavity is totally filled with feedstock. In the making of foamed articles, however, each mold cavity is initially only partially filled. It is the action of the blowing agents creating the foam structure of the foamed article which assures the complete filling of each mold cavity.)

It has been found that foamed articles made in a molding process are of superior quality where excess blowing agent gas is allowed to escape from the mold cavities during the forming operation. An important advantage of the use of a mechanical latch 38 is that it allows for the creation of a small air gap 40 between respective pairs of mold portions 16 to allow the escape of excess blowing agent gas during the forming process. In a typical embodiment, such air gap 40 is between about 0.005 inches and about 0.020 inches. Preferably, each mechanical latch 38 is adjustable so that the air gap 40 between respective pairs of mold portions is adjustable in width.

In operation, thermoplastic resin feedstock is mixed with a requisite amount of blowing agent and the resulting feedstock blend is stored in the hopper 28. A quantity of the feedstock blend is metered into the injection unit 14 sufficient to provide a complete charge of feedstock blend to one of the two mold modules 12. Within the injection unit 14, the feedstock blend is heated to an appropriate temperature. Because the volume of the injection unit 14 is initially totally occupied by the liquid feedstock blend, the heating of the feedstock blend does not cause the foaming of the feedstock blend.

When the first mold module 12a is ready to accept a new charge of feedstock blend, the second mold portion 16b is moved to the closed position by the linear actuators 18, and the mechanical latch 38 is engaged to retain the two mold portions 16 in the closed position. In a preferred embodiment, a tiny air gap 40 is left between the two mold portions 16. The distributor head 30 is then opened to the first module 12a to allow feedstock blend within the injection unit 14 to flow into that mold module 12a. Each of the mold cavities is only partially filled with feedstock blend. (The excess volume of each mold cavity allows sufficient room for the feedstock blend to foam. The foaming of the feedstock blend causes the feedstock blend to fully occupy all of the volume within each mold cavity.) The foamed feedstock blend is allowed to set for a short period of time within the first mold module 12a.

While foamed articles are being formed within the first mold module 12a, the mechanical latch 38 on the second mold module 12b is moved to the unlatched position and the linear actuators 18 on the second mold module 12b are activated to move the second mold portion 16b to the open position, whereupon molded articles within each of the mold cavities within the second mold module 12b are removed. The second mold portion 16b of the second mold module 12b is then moved to the closed position by the linear actuators 18, and the mechanical latch 38 is redisposed to the latched position to retain the second mold module 12b in the closed position. A tiny air gap 40 is also left between the two mold portions 16 of the second mold module 12b. At this point, the distributor head 30 is configured to allow flow of blended feedstock from the injection unit 14 to the second mold module 12b. After the prescribed amount of blended feedstock is transmitted to the second mold module 12a, the blended feedstock within the second mold module 12b is caused to foam by the blowing agent and each of the mold cavities within the second mold module 12b becomes totally occupied by foamed feedstock blend. The foamed feedstock blend is retained within the second mold module 12b for a period of time sufficient for the blended feedstock to harden into foamed articles.

During this time, the latch mechanism 38 on the first mold module 12a is moved to the unlatched position, the second mold portion 16b of the first mold module 12a is moved to the open position and foamed articles within the first mold module 12a are removed from the mold cavities. After foamed articles are removed from the mold cavities of the first mold module 12a, the second mold portion 16b of the first mold module 12a is moved back to the closed position and the mechanical latch 38 is again moved to the latched position to retain the first mold module 12a in the closed position. At this point, the operation of the distributor head 30 is reoriented to allow new blended feedstock to flow from the injection unit 14 into the first mold module 12a and the complete mold cycle described above is repeated.

The apparatus of the invention has been found to have several advantages over apparatuses of the prior art. First of all, the use of two mold modules fed by a single injection unit allows for proper residence time within each mold module by minimizing residence time within the injection unit. This avoids problems caused by the “overcooking” of feedstock blend within the distribution unit. Secondly, the use of mechanical latches avoids the expense and awkwardness of having to use traditional hydraulic clamping mechanisms to retain the mold modules in their respective closed positions. Instead, the mold modules can be opened and closed by a pair of small and inexpensive linear actuators (and the mold portions are retained in the closed positions by the simple, lightweight and inexpensive mechanical latch). Finally, the use of a mechanical latch allows for an air gap to be provided between each of the pairs of mold portions. As indicated above, the molding of foamed articles using such an air gap provides molded articles of superior quality.

Although the description above contains many specifications, these should not be construed as limiting the scope of the invention but as merely providing illustrations of some of the presently preferred embodiments of this invention.

What is claimed is:

1. A mold apparatus useful for making molded foam articles, the mold apparatus comprising:
(a) a first mold module having a plurality of mold cavities, the first mold module comprising a first portion and a second portion, the first portion and the second portion being moveable with respect to one another between an open position and a closed position;
(b) a second mold module having a plurality of mold cavities, the second mold module comprising a first portion and a second portion, the first portion of the second mold module and the second portion of the second mold module being moveable with respect to one another between an open position and a closed position; and
(c) a hot melt injection unit for heating and delivering one or more components of a molded foam article feedstock, the hot melt injection unit being capable of alternatively directing feedstock to the first mold module or to the second mold module.

2. The mold apparatus of claim 1 wherein the first mold module and the second mold module are both retained within their respective closed positions by a mechanical latch.

3. The mold apparatus of claim 1 wherein, (i) when the first mold module is disposed within the closed position, an air gap is provided between the first portion of the first mold module and the second portion of the first mold module, the air gap being between 0.005 inches and 0.020 inches, and (ii) when the second mold module is disposed within the closed position, an air gap is provided between the first portion of the second mold module and the second portion of the second mold module, the air gap within the second mold module being between 0.005 inches and 0.020 inches.

4. The mold apparatus of claim 1 wherein, (i) when the first mold module is disposed within the closed position, an air gap is provided between the first portion of the first mold module and the second portion of the first mold module, the air gap being between 0.005 inches and 0.020 inches, and (ii) when the second mold module is disposed within the closed position, an air gap is provided between the first portion of the second mold module and the second portion of the second mold module, the air gap within the second mold module being between 0.005 inches and 0.020 inches, and wherein both the first mold module and the second mold module are retained within their respective closed positions by a mechanical latch.

5. The mold apparatus of claim 4 wherein each mechanical latch is adjustable such that the air gaps provided when the first mold module and the second mold module are disposed within their respective closed positions are both adjustable.

6. The mold apparatus of claim 1 wherein the hot melt injection unit comprises an upstream end and a downstream end, the downstream end having a rotary valve capable of alternatively directing feedstock to the first mold module or to the second mold module.

7. The mold apparatus of claim 1 wherein the hot melt injection unit comprises an upstream end and a downstream end, the downstream end having a three-way valve capable of alternatively directing feedstock to the first mold module or to the second mold module.

8. The mold apparatus of claim 1 wherein the hot melt injection unit comprises an upstream end and a downstream end, the downstream end having a plurality of valves capable of alternatively directing feedstock to the first mold module or to the second mold module.

9. The mold apparatus of claim 1 wherein the first portion of each mold module is stationary and the second portion of each mold module is moveable and wherein the hot melt injection unit is capable of alternatively directing feedstock to the first portion of the first mold module or to the first portion of the second mold module.

10. A mold apparatus useful for making molded foam articles, the mold apparatus comprising:
(a) a first mold module having a plurality of mold cavities, the first mold module comprising a stationary first portion and a moveable second portion, the first portion and the second portion being moveable with respect to one another between an open position and a closed position;
(b) a second mold module having a plurality of mold cavities, the second mold module comprising a stationary first portion and a moveable second portion, the first portion and the second portion being moveable with respect to one another between an open position and a closed position;
(c) a hot melt injection unit for heating and delivering one or more components of a molded foam article feedstock, the hot melt injection unit comprising an upstream end and a downstream end, the downstream end having a rotary valve capable of alternatively directing feedstock to the first portion of the first mold module or to first portion of the second mold module;
wherein, (i) when the first mold module is disposed within the closed position, an air gap is provided between the first portion of the first mold module and the second portion of the first mold module, the air gap being between 0.005 inches and 0.020 inches, and (ii) when the second mold module is disposed within the closed position, an air gap is provided between the first portion of the second mold module and the second portion of the second mold module, the air gap within the second mold module being between 0.005 inches and 0.020 inches.

11. The mold apparatus of claim 10 wherein both the first mold module and the second mold module are retained within their respective closed positions by a mechanical latch.

12. The mold apparatus of claim 11 wherein each mechanical latch is adjustable, such that the air gaps provided when the first mold module and the second mold module are disposed within their respective closed positions are both adjustable.

13. A mold apparatus useful for making molded foam articles, the mold apparatus having a plurality of mold cavities and further comprising:
(a) a first mold portion and a second mold portion, the first mold portion and the second mold portion being moveable with respect to one another between an open position and a closed position; and
(b) a hot melt injection unit for heating and delivering one or more components of a molded foam article feedstock, the hot melt injection unit being capable of alternatively directing feedstock to the first mold module or to the second mold module;
wherein, when the first mold portion and the second mold portion are disposed within the closed position, an air gap is provided between the first mold portion and the second mold portion, the air gap being between 0.005 inches and 0.020 inches.

14. The apparatus of claim 13 wherein the first mold portion and the second mold portion are retained within the closed position by a mechanical latch.

15. The mold apparatus of claim 14 wherein the mechanical latch is adjustable such that the air gap provided when the first mold portion and the second mold portion are disposed within the closed position is adjustable.

16. A method for making molded foam articles comprising the steps of:
(a) providing a mold apparatus comprising:
(i) a first mold module having a plurality of mold cavities, the first mold module comprising a first portion and a second portion, the first portion and the second portion being moveable with respect to one another between an open position and a closed position;
(ii) a second mold module having a plurality of mold cavities, the second mold module comprising a first portion and a second portion, the first portion and the second portion being moveable with respect to one another between an open position and a closed position; and
(iii) a hot melt injection unit for mixing, heating and delivering one or more components of a molded foam article feedstock, the hot melt injection unit being capable of alternatively directing feedstock to the first mold module or to the second mold module;
(b) combining molded foam article starting resin and a blowing agent to form a molded foam article feedstock;
(c) heating the molded foam article feedstock;
(d) delivering some of the molded foam article feedstock with the hot melt injection unit to the first mold module;
(e) molding molded foam article feedstock in the first mold module while heating other of the molded foam article feedstock in the hot melt injection unit;
(f) delivering some of the molded foam article feedstock with the hot melt injection unit to the second mold module and removing molded foam articles from the first mold module;
(g) molding molded foam article feedstock in the second mold module while heating other of the molded foam article feedstock in the hot melt injection unit;
(h) delivering some of the molded foam article feedstock with the hot melt injection unit to the first mold module and removing molded foam articles from the second mold module; and
(i) repeating steps (e)-(h) at least ten times.

17. The method of claim 16 wherein the molded foam article starting resin comprises a blend of polypropylene and thermoplastic elastomer.

18. The method of claim 16 wherein the molding of molded foam article feed stock in the first mold module in step (e) is carried out while maintaining an air gap between the first portion of the first mold module and the second portion of the first mold module, such air gap being between 0.005 inches and 0.020 inches, and wherein the molding of molded foam article feed stock in the second mold module in step (g) is carried out while maintaining an air gap between the first portion of the second mold module and the second portion of the second mold module, such air gap between the first portion of the second mold module and the second portion of the second mold module being between 0.005 inches and 0.020 inches.

19. The method of claim 18 wherein, during the molding of molded foam article feed stock within the first mold module in step (e), the air gap between the first portion of the first mold module and the second portion of the first mold module is maintained by a mechanical latch and wherein during the molding of molded foam article feed stock in the second mold module in step (g), the air gap between the first portion of the second mold module and the second portion of the second mold module is maintained by a mechanical latch.

20. The method of claim 19 wherein, prior to the molding of molded foam article feed stock in the first mold module in step (e), the air gap between the first portion of the first mold module and the second portion the first mold module is adjusted.

21. A method for making molded foam articles comprising the steps of:
(a) providing a mold apparatus comprising:
(i) a first mold portion and a second mold portion, the first mold portion and the second mold portion being moveable with respect to one another between an open position and a closed position; and
(ii) a hot melt injection unit for heating and delivering one or more components of a molded foam article feedstock, the hot melt injection unit being capable of alternatively directing feedstock to the first mold module or to the second mold module;
wherein, when the first mold portion and the second mold portion are disposed within the closed position, an air gap is provided between the first mold portion and the second mold portion, the air gap being between 0.005 inches and 0.020 inches;
(b) combining molded foam article starting resin and a blowing agent to form a molded foam article feedstock;
(c) heating the molded foam article feedstock;
(d) delivering some of the molded foam article feedstock with the hot melt injection unit to the mold cavities; and
(e) molding molded foam article feedstock within the mold cavities while maintaining the first mold portion and the second mold portion disposed in the closed position with an air gap between the first mold portion and the second mold portion of 0.005 inches and 0.020 inches.

22. The method of claim 21 wherein, prior to the molding of foam article feed stock in step (e), the air gap between the first mold portion and the second mold portion when the first mold portion and the second mold portion are disposed within the closed position is adjusted.
